(19) United States
(12) Patent Application Publication
(10) Pub. No.: US 2014/0292168 A1
(43) Pub. Date: Oct. 2, 2014

(54) MULTIPLE TIER HOLDING DISPLAY AND METHOD

(71) Applicant: MANITOWOC FOODSERVICE COMPANIES, LLC, Maintowoc, WI (US)

(72) Inventor: Roberto Nevarez, Hudson, FL (US)

(21) Appl. No.: 14/350,317

(22) PCT Filed: Oct. 17, 2012
(86) PCT No.: PCT/US2012/060664

§ 371 Date: Apr. 7, 2014

Related U.S. Application Data
(60) Provisional application No. 61/550,843, filed on Oct. 24, 2011.

(51) Int. Cl. A47J 39/00; F21K 99/00

(52) U.S. Cl. CPC A47J 39/003; F21K 9/00
USPC 312/236; 362/227; 362/249.02; 219/214; 29/592.1

(57) ABSTRACT

A food holding cabinet that has multiple tiers with moisture even distribution, lighting and heating features. The moisture feature provides a circulating moisture laden airflow to a tier. The lighting feature provides low energy consuming light emitting diodes to a tier. The heating feature provides different heating to different heating zones.

### CROSS-REFERENCED APPLICATIONS

This application is a national phase application of PCT Application No. PCT/US2012/060664, filed on Oct. 17, 2012, which claims priority to U.S. Provisional Application No. 61/550843, filed on Oct. 24, 2011, both of which are incorporated herein by reference in their entirety.

### BACKGROUND

1. Field of the Disclosure

This disclosure relates to a multiple tier holding display for holding and displaying food products for selection by a user.

2. Discussion of the Background Art

Current holding display cabinets have several disadvantages. The current holding display cabinets are typically only two tier and narrow and long and require an awkward and large footprint, which is difficult for many present day commercial food service environments. The current holding display cabinets typically use halogen lamps that result in hot spots forming on the displayed food products. The current holding display cabinets provide heat and moisture that is not evenly delivered to the food products.

There is a need for a holding display cabinet that overcomes the disadvantages of the current holding display cabinets.

### SUMMARY OF THE DISCLOSURE

In one embodiment of the food display cabinet according to the present disclosure, a plurality of walls defines a food holding compartment. A ductwork is disposed in fluid communication with the food holding compartment. A reservoir that holds water is disposed in the ductwork. A heating element is disposed to heat the water to provide moisture above the water. A fan is disposed in the ductwork to provide a circulating airflow laden with the moisture between the ductwork and the food holding compartment.

In another embodiment of the food display cabinet according to the present disclosure, the ductwork comprises a first duct that distributes the airflow laden with moisture evenly throughout the food holding compartment.

In another embodiment of the food display cabinet according to the present disclosure, the ductwork comprises a second duct that is disposed below a bottom wall of the plurality of walls. The fan and water reservoir are disposed in the second duct.

In another embodiment of the food display cabinet according to the present disclosure, the ductwork comprises a third duct that extends lengthwise across an edge of the bottom wall and a plurality of apertures disposed to take in the circulating airflow.

In another embodiment of the food display cabinet according to the present disclosure, a plurality of walls defines at least one food holding tier. A plurality of light emitting diodes is disposed in an arrangement to illuminate the food holding tier.

In another embodiment of the food display cabinet according to the present disclosure, the arrangement comprises at least one row of light emitting diodes.

In another embodiment of the food display cabinet according to the present disclosure, a plurality of shelves together with the plurality of walls define multiple tiers, which include the at least one food holding tier. The plurality of diodes is disposed in a plurality of arrangements, one for each tier.

In another embodiment of the food display cabinet according to the present disclosure, the arrangement of light emitting diodes is disposed in a holder so as to direct light inwardly and downwardly into the food holding tier.

In another embodiment of the food display cabinet according to the present disclosure, the cabinet comprises at least one shelf. An arrangement of one or more heating elements is disposed to heat first and second heating zones of the shelf so that the first heating zone is warmer than the second heating zone.

In another embodiment of the food display cabinet according to the present disclosure, the first heating zone and the second heating zone are adjacent a front edge and a back edge, respectively, of the shelf.

In another embodiment of the food display cabinet according to the present disclosure, the arrangement comprises a serpentine winding of at least one of the heating elements in at least one of the first and second heating zones.

In another embodiment of the food display cabinet according to the present disclosure, the arrangement comprises a first and a second heating element of the plurality of heating elements. The first and second heating elements are arranged in first and second serpentine windings in the first and second heating zones with the first serpentine winding having more turns than the second serpentine winding.

An embodiment of a first method of the present disclosure injects moisture into a food holding compartment defined by a plurality of walls. The method comprises: providing a ductwork in fluid communication with the food holding compartment; disposing a reservoir in the ductwork; heating water in the reservoir to form moisture above the water; and circulating an airflow laden with the moisture between the ductwork and the food holding compartment.

In another embodiment of the first method of the present disclosure, the ductwork comprises a first duct that distributes the airflow laden with moisture evenly throughout the food holding compartment.

In another embodiment of the first method of the present disclosure, the ductwork comprises a second duct that is disposed below a bottom wall of the plurality of walls and the reservoir is disposed in the second duct.

In another embodiment of the first method of the present disclosure, the ductwork comprises a third duct that extends lengthwise across an edge of the bottom wall and that comprises a plurality of apertures disposed to take in the circulating airflow.

In an embodiment of a second method according to the present disclosure a food display cabinet is illuminated by: forming a food holding tier in the food display cabinet; and disposing a plurality of light emitting diodes in an arrangement to illuminate the food holding tier.

In another embodiment of the second method according to the present disclosure, the arrangement comprises at least one row of the light emitting diodes.

In another embodiment of the second method according to the present disclosure, the second method further comprises: providing a plurality of shelves that together with the plurality of walls define multiple tiers, which include the at least one food holding tier; and disposing the plurality of light emitting diodes in a plurality of arrangements, one for each of the food holding tiers.

In another embodiment of the second method according to the present disclosure, the second method further comprises: disposing the arrangement of light emitting diodes in a holder; and positioning the holder so that light emitted by the light emitting diodes is directed inwardly and downwardly into the food holding tier.

In an embodiment of a third method according to the present disclosure, a food display cabinet is formed by: providing at least one shelf; and disposing an arrangement of one or more heating elements to heat first and second heating zones of the shelf so that the first heating zone is warmer than the second heating zone.

In another embodiment of the third method according to the present disclosure, the third method further comprises: positioning the first heating zone and the second heating zone adjacent a front edge and a back edge, respectively, of the shelf.

In another embodiment of the third method according to the present disclosure, the third method further comprises: forming the arrangement with a serpentine winding of at least one of the heating elements in at least one of the first and second heating zones.

In another embodiment of the third method according to the present disclosure, the third method further comprises: forming the arrangement with a first and a second heating element of the plurality of heating elements. The first and second heating elements are arranged in first and second serpentine windings in the first and second heating zones. The first serpentine winding has more turns than the second serpentine winding.

### BRIEF DESCRIPTION OF THE DRAWINGS

Other and further objects, advantages and features of the present disclosure will be understood by reference to the following specification in conjunction with the accompanying drawings, in which like reference characters denote like elements of structure and:

FIG. 1 is a perspective view of a holding display of the present disclosure;

FIG. 2 is a front view of the holding display of FIG. 1;

FIG. 3 is a rear view of the holding display of FIG. 1;

FIG. 4 is a side view of the holding display of FIG. 1;

FIG. 5 is a top view of the holding display of FIG. 1;

FIG. 6 is a cross-sectional view taken along line 6 of FIG. 2;

FIG. 7 is a bottom perspective cross-sectional view taken along line 6 of FIG. 2;

FIG. 8 is a top perspective cross-sectional view taken along line 6 of FIG. 2;

FIG. 9 is a cross-sectional view taken along line 9 of FIG. 2;

FIG. 10 is a perspective view of a light support duct of the holding display of FIG. 1;

FIG. 11 is a perspective view of a portion of the holding display of FIG. 1 with the left side and windows removed; and

FIG. 12 is a cross-sectional view taken along line 12 of FIG. 10.

### DETAILED DESCRIPTION OF THE PREFERRED EMBODIMENT

A multiple tier holding display cabinet of the present disclosure provides at least two tiers and preferably at least three tiers. By way of example, an embodiment of the multiple tier holding cabinet, which has three tiers, is described herein. Some of the features described herein may also find use in food holding cabinets that have a single tier, double tier and even more than three tiers.

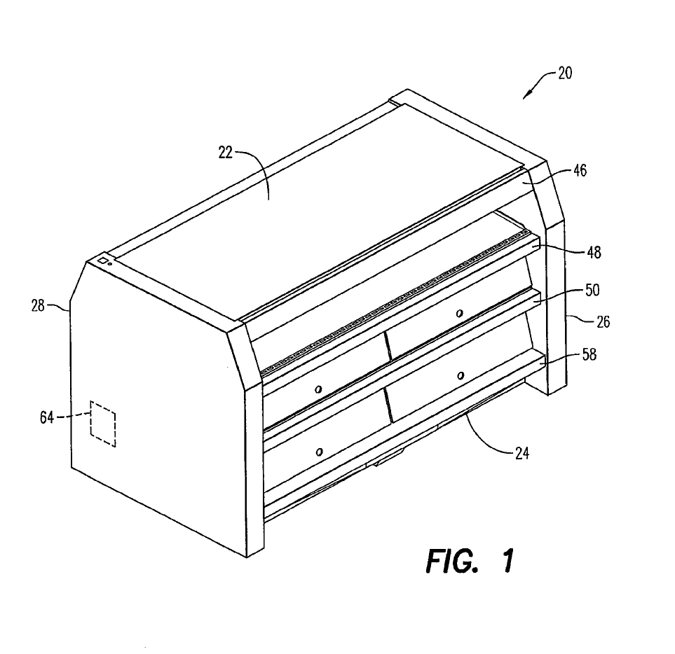

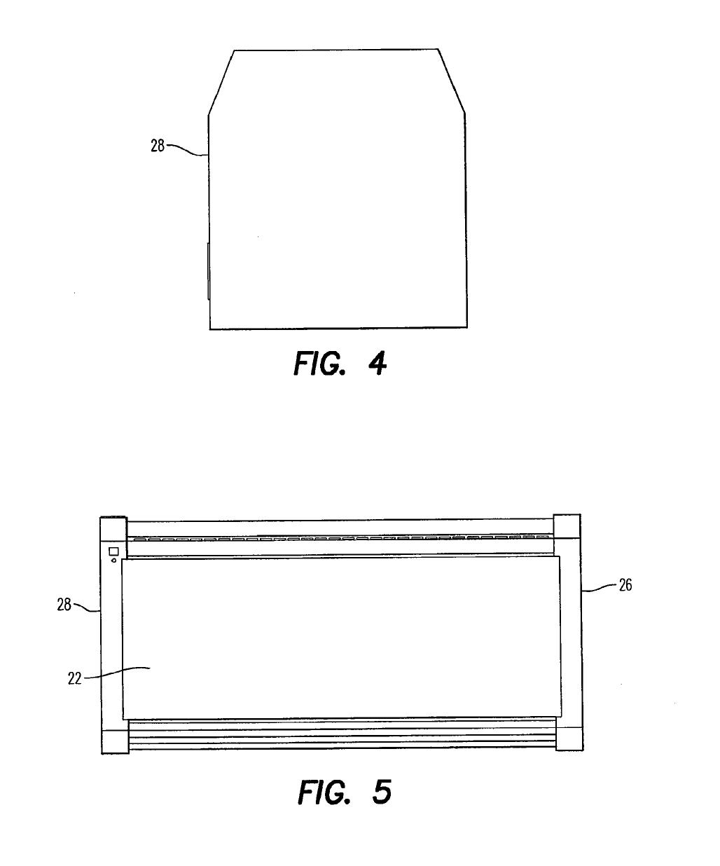

Referring to FIGS. 1-6, a food holding display cabinet 20 comprises a top wall 22, a bottom wall 24 and sidewalls 26 and 28 that are fastened together by any suitable fasteners, such as screws or bolts. These walls, for example, may suitably be stainless steel or other metal.

Three shelves 30, 32 and 34 (shown in FIG. 6) are fastened to sidewalls 26 and 28 so as to form compartments or tiers 36, 38 and 40. Shelves 30, 32 and 34 are angled slightly downward toward the front of display cabinet 20 to allow for better visibility from the customer's end.

A pair of windows 42 is connected via hinges 44 to a front of compartments 36 and 38 and a back of compartments 38 and 40. This allows these windows to be opened by rotation outwardly and upwardly from display cabinet 20. Another pair of unhinged windows 42 is connected to a back of compartment 36. Windows 42 are preferably transparent, but could be opaque. A front window could optionally be provided for compartment 40. Windows 42 can be formed of glass, plastic or metal.

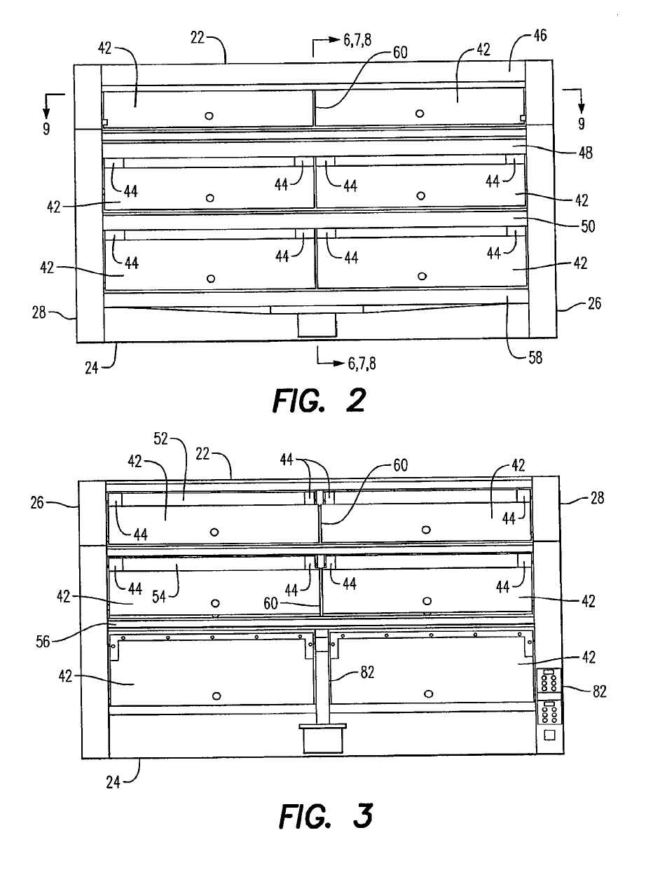

Referring to FIGS. 1-3 and 6, a duct 46 and a duct 52 are fastened to a front edge and a back edge of top wall 22, respectively. A light support duct 48 and a light support duct 50 are fastened to front edges of shelves 34 and 32, respectively. Optionally, duct 46 may also be a light support. A duct 54 and a duct 56 are fastened to back edges of shelves 34 and 32, respectively. A duct 58 is fastened to a front edge of shelf 30. Vertical supports 60 are disposed intermediate of sidewalls 26 and 28 to provide additional support for shelves 32 and 34 as shown in FIGS. 2, 3 and 7.

Referring to FIGS. 1 and 3, a control panel 62 is disposed on a backside of sidewall 28. Control panel 62 includes manual controls such as an on/off switch and other manual controls. A controller 64 is disposed in sidewall 28 with connections to control panel 62 and to various other components as set forth below.

Referring to FIGS. 2, 3, 6 and 7, a reservoir 70 is disposed intermediate sidewalls 26 and 28 between bottom wall 24 and shelf 30. Preferably, reservoir 70 is disposed about midway between sidewalls 26 and 28. Reservoir 70 holds a liquid, such as water, to provide moisture. A water connection 72 is disposed in a sidewall of reservoir 70. Water connection 72 is connected to a water source (not shown) and a water valve (not shown) to provide water to reservoir 70 under control of controller 64. Float valves (not shown) may also be deployed in the water to provide low and high water level signals via electrical connections (not shown) to controller 64. An electrical heating element 74 is also disposed in reservoir 70 to heat the water. Heating element 74 has an electrical connector 76 that is connected to controller 64.

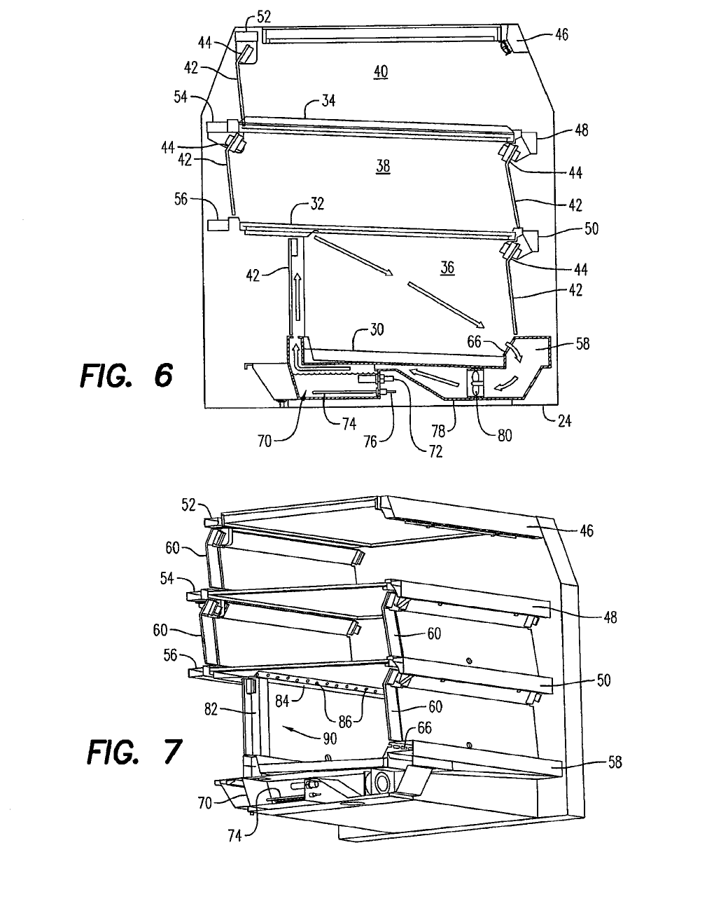

Reservoir 70 is in fluid communication with a duct 78, a fan 80, a moisture delivery ductwork 90 and duct 58 to deliver an even distribution of moisture to compartment 36. Fan 80 is disposed in duct 78 and is operable to circulate moisture laden airflow to compartment 36. Duct 78 has an extension into reservoir 70 above the water and a connection to duct 58. Moisture delivery ductwork 90, which is located adjacent the back of shelf 30, comprises a vertical duct 82 connected on its lower end to reservoir 70 and at its upper end to a horizontal duct 84 that extends along the length of compartment 36 between side walls 26 and 28. Horizontal duct 84 has a plurality of apertures 86 disposed in a pattern along the length of horizontal duct 84 that provides an even flow of moisture into compartment 36. As shown in FIG. 7, this pattern has a horizontal row of apertures. In an alternate embodiment, pattern may include two rows of apertures with the apertures of one row being offset from the apertures of the other row. Other patterns are possible to deliver an even distribution of moisture along the length and width of compartment 36. Vertical duct 82 also provides support for shelf 32 as shown in FIG. 3.

Duct 58, which is fastened to a front edge of shelf 32, has a plurality of apertures 66 (shown in FIG. 7) distributed in a row that extends along its length between sidewalls 26 and 28. Apertures 66 are shown as slots oriented in the lengthwise direction, but may have other shapes, for example, circular, oval and other shapes, and orientations, for example, widthwise, slanted and others. Duct 58 is in fluid communication via apertures 66 with duct 78. For example, duct 78 extends along duct 58 so as to encompass apertures 66.

In operation, controller 64 operates fan 80 via electrical connections (not shown) to circulate air in a path that includes duct 78, water reservoir 70, moisture delivery ductwork 90 and duct 58 as shown by the arrows in FIG. 6. Moisture from the heated water enters the circulating air in reservoir 70. The moisture laden air flows upwardly through vertical duct 82, through horizontal duct 84 and via apertures 84 into compartment 36, through compartment 36 and into duct 58 via apertures 66, and returns to duct 78.

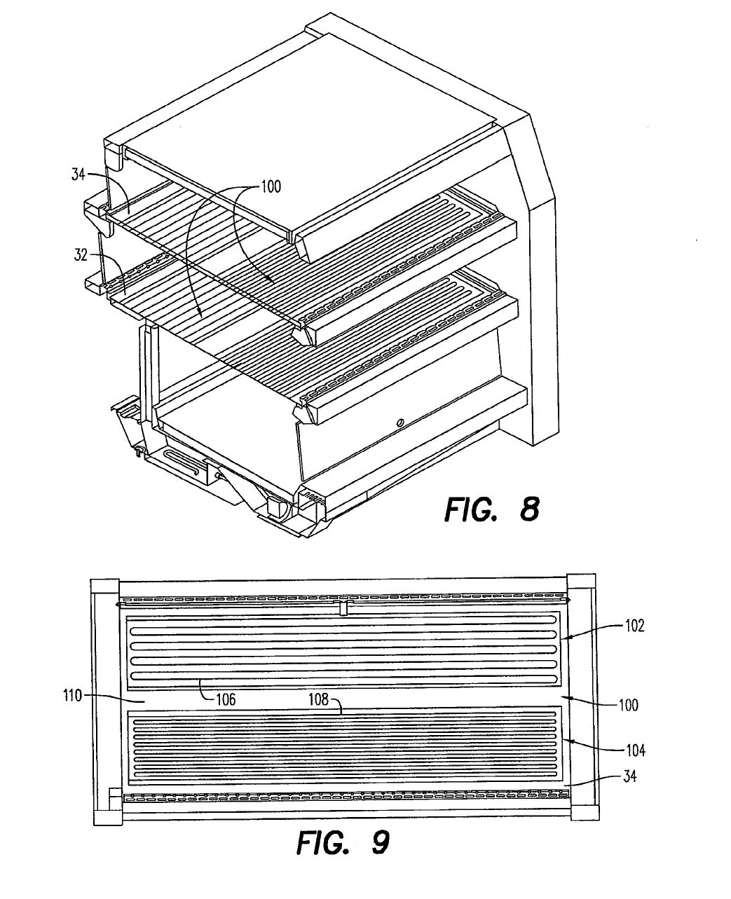

Referring to FIGS. 8 and 9, shelves 32 and 34 each have an electrical heating assembly 100. As electrical heating assembly 100 is identical for both shelves, heating assembly 100 will be described for only shelf 34. Heating assembly 100 comprises a first heating zone 102 and a second heating zone 104, located adjacent a back edge and a front edge of shelf 34, respectively. A divider strip 110 separates first and second heating zones from one another. Heating assembly 100 comprises a first heating element 106 and a second heating element 108 disposed on a top surface of shelf 32 in first and second heating zones 102 and 104, respectively. Each heating element 106 and 108 is arranged in a serpentine pattern that extends along the length of shelf 32. The number of turns or horizontal runs of second heater element 108 is greater than the number of horizontal runs of first heater element 106. This results in more heat being provided in second heating zone 104 than in first heating zone 102. That is, second heating zone 104, which is near the front of display cabinet 20, will be warmer than the first heating zone 102 near the back of display cabinet 20. Electrical heating elements 106 and 108 each have connections to controller 64 for independent control. However, in other embodiments, electrical heating elements 106 and 108 may be connected in the same circuit to controller 64. Though not shown in FIGS. 8 and 9, similar electrical heating elements may also be disposed on the top surface of shelf 30. Optionally, electrical heating elements may also or alternatively be disposed on the bottom surfaces of shelves 32 and 34 and/or the bottom surface of top wall 22.

First and second electrical heating elements 106 and 108 may be any electrical heating elements that can be disposed on the surface of a shelf in the desired patterns. Preferably, first and second electrical heating elements 106 and 108 comprise a heater foil.

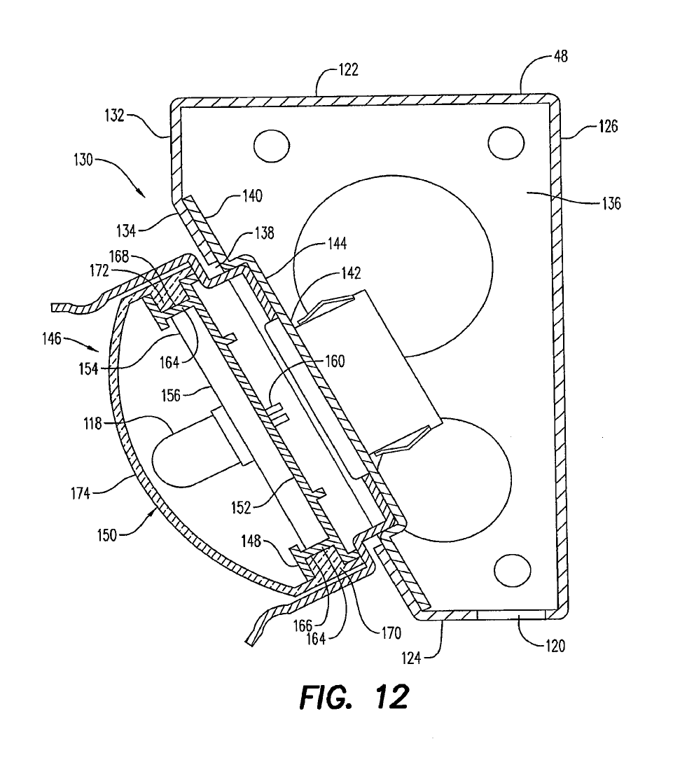

Referring to FIGS. 7 and 10-12, light support ducts 48 and 50 each support a plurality of light emitting diodes (LEDs) 118. Optionally, a light support with LEDs 118 may be attached to the front edge of top wall 22 to provide light into compartment 40 as shown in FIG. 11. Since light support ducts 48 and 50 are identical, only light support duct 48 will be described in detail.

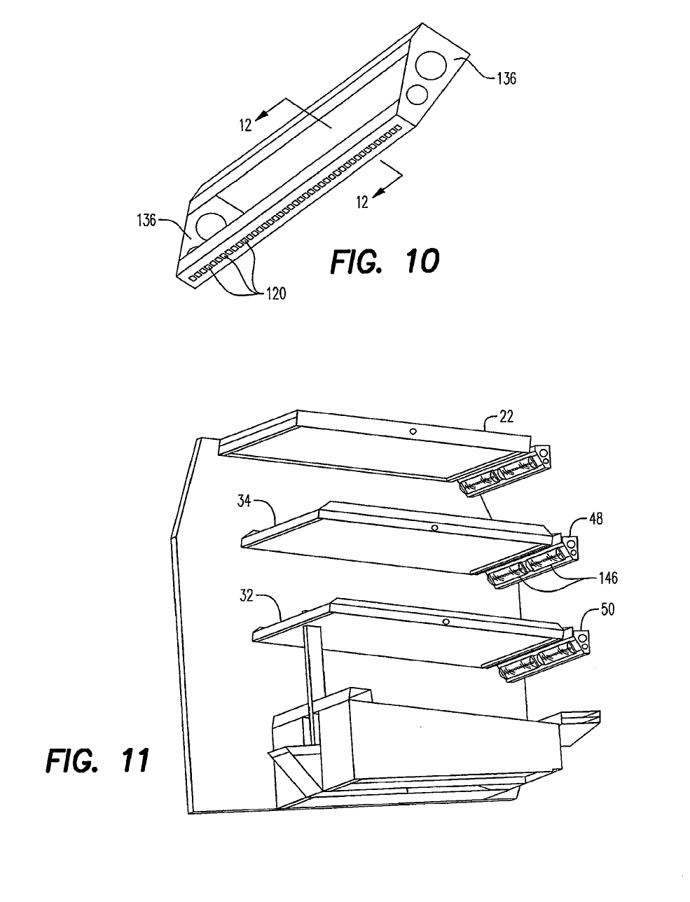

LEDs 118 are positioned to direct light inwardly and downwardly into compartments 36 and 38. Light support duct 48 comprises a plurality of openings 120 for air circulation so that heat generated by LEDs 118 escapes via openings 120 to ambient. Light support duct 48 comprises a top 122, a bottom 124, a side 126, a side 130 and end pieces 136. End pieces 136 are located at opposite ends of light support duct 18 as shown in FIG. 10.

Side 130 comprises a vertical side portion 132 and a sloped side portion 134. Vertical side portion 132 and side 126 are parallel to one another and shown in the vertical position for the illustrated embodiment, i.e., side portion 132 and side 126 may be oriented at an angle to the vertical in other embodiments. Sloped side portion 134 comprises one or more openings 138 along its length for mounting LEDs 118.

A bracket 140 is fastened to and along a length of an interior surface of sloped side portion 132. Bracket 140 comprises a recess 144. An opening 142 is disposed in recess 144 to provide a fluid communication for air circulation to openings 120.

As shown in FIG. 11, two LED assemblies 146 are disposed along a length of light support duct 48 and two LED assemblies 146 are disposed along a length of light support duct 50. In other embodiments one or more than two LED assemblies can be disposed in light support ducts 146 and 150 and/or in light support duct 46 as well.

LED assembly 146 comprises a holder 148 and a cover 150. Holder 148 comprises a pair of spaced apart side rails 164 that extend along a length of light support duct 48 and define a central recess 152 and side recesses 166 and 168. Central recess 152 and side recesses 164 and 166 also extend along the length of light support duct 48. A board 154 fits within recess 152 and comprises a plurality of spaced apart holes 156 arranged in a row. Separate ones of LEDs 118 are mounted to board 154 so as to extend through separate ones of holes 156 and through a passage 162 of holder 148. Each LED 156 includes a pair of terminals 160 for connection to electrical wiring (not shown) extending through an opening 142 into light support duct 48 and to controller 64. In an alternate embodiment, opening 142 may include separate holes for separate ones of LEDs 118 or a single hole, e.g., a slot, which extends along the length of holder 148.

Cover 150 extends along the length of holder 148 and comprises abutments 170 and 172 that fit within side recesses 166 and 168, respectively. Cover 150 further comprises a lens portion 174 that extends in an arc to provide cover LEDs 118 with protection from accumulating dust, dirt and/or food by-products, such as food particles, grease and the like. Lens portion 174 is preferably transparent and formed of a material that disperses emitted light from LEDs 118 to uniformly cover the interior of compartment 38.

LED assembly 146 fits between the arms 180 of a brace 176 that is attached to bracket 140. Arms 180 may have a property of elasticity to allow a snap in installation and snap out removal of LED assembly 146.

The present disclosure having been thus described with particular reference to the preferred forms thereof, it will be obvious that various changes and modifications may be made therein without departing from the scope of the present disclosure as defined in the appended claims.

What is claimed is:

1. A food display cabinet comprising:
a plurality of walls that define a food holding compartment;
a ductwork disposed in fluid communication with said food holding compartment;
a reservoir that holds water disposed in said ductwork;
a heating element disposed to heat said water to provide moisture above the water; and
a fan disposed in said ductwork that provides a circulating airflow laden with said moisture between said ductwork and said food holding compartment.

2. The food display cabinet of claim 1, wherein said ductwork comprises a first duct that distributes said airflow laden with moisture evenly throughout said food holding compartment.

3. The food display cabinet of claim 2, wherein said ductwork comprises a second duct that is disposed below a bottom wall of said plurality of walls and wherein said fan and water reservoir are disposed in said second duct.

4. The food display cabinet of claim 3, wherein said ductwork comprises a third duct that extends lengthwise across an edge of said bottom wall and that comprises a plurality of apertures disposed to take in said circulating airflow.

5. A food display cabinet comprising:
a plurality of walls that define at least one food holding tier; and
a plurality of light emitting diodes that is disposed in an arrangement to illuminate said food holding tier.

6. The food holding display cabinet of claim 5, wherein said arrangement comprises at least one row of said light emitting diodes.

7. The food holding display cabinet of claim 6, further comprising: a plurality of shelves that together with said plurality of walls define multiple tiers, which include said at least one food holding tier; and wherein said plurality of light emitting diodes is disposed in a plurality of arrangements, one for each tier.

8. The food holding cabinet of claim 5, wherein said arrangement of light emitting diodes is disposed in a holder, which is positioned so that light emitted by said light emitting diodes is directed inwardly and downwardly into said food holding tier.

9. A food display cabinet comprising:
at least one shelf; and
an arrangement of one or more heating elements disposed to heat first and second heating zones of said shelf so that said first heating zone is warmer than said second heating zone.

10. The food display cabinet of claim 9, wherein said first heating zone and said second heating zone are adjacent a front edge and a back edge, respectively, of said shelf.

11. The food display cabinet of claim 9, wherein said arrangement comprises a serpentine winding of at least one of said heating elements in at least one of said first and second heating zones.

12. The food display cabinet of claim 9, wherein said arrangement comprises a first and a second heating element of said plurality of heating elements, wherein said first and second heating elements are arranged in first and second serpentine windings in said first and second heating zones, and wherein said first serpentine winding has more turns than the second serpentine winding.

13. A method for injecting moisture into a food holding compartment defined by a plurality of walls comprising:
providing a ductwork in fluid communication with said food holding compartment;
disposing a reservoir in said ductwork;
heating water in said reservoir to form moisture above the water; and
circulating an airflow laden with said moisture between said ductwork and said food holding compartment.

14. The method of claim 13, wherein said ductwork comprises a first duct that distributes said airflow laden with moisture evenly throughout said food holding compartment.

15. The method of claim 14, wherein said ductwork comprises a second duct that is disposed below a bottom wall of said plurality of walls and wherein said reservoir is disposed in said second duct.

16. The method of claim 15, wherein said ductwork comprises a third duct that extends lengthwise across an edge of said bottom wall and that comprises a plurality of apertures disposed to take in said circulating airflow.

17. A method of illuminating a food display cabinet comprising:
forming a food holding tier in said food display cabinet; and
disposing a plurality of light emitting diodes in an arrangement to illuminate said food holding tier.

18. The method of claim 17, wherein said arrangement comprises at least one row of said light emitting diodes.

19. The method of claim 18, further comprising:
providing a plurality of shelves that together with said plurality of walls define multiple tiers, which include said at least one food holding tier; and
disposing said plurality of light emitting diodes in a plurality of arrangements, one for each of said food holding tiers.

20. The method of claim 17, further comprising:
disposing said arrangement of light emitting diodes in a holder; and
positioning said holder so that light emitted by said light emitting diodes is directed inwardly and downwardly into said food holding tier.

21. A method for forming a food display cabinet comprising:
providing at least one shelf; and
disposing an arrangement of one or more heating elements to heat first and second heating zones of said shelf so that said first heating zone is warmer than said second heating zone.

22. The method of claim 21, further comprising:
positioning said first heating zone and said second heating zone adjacent a front edge and a back edge, respectively, of said shelf.

23. The method of claim 21, further comprising:
forming said arrangement with a serpentine winding of at least one of said heating elements in at least one of said first and second heating zones.

24. The method of claim 21, further comprising:
forming said arrangement with a first and a second heating element of said plurality of heating elements, wherein said first and second heating elements are arranged in first and second serpentine windings in said first and second heating zones, and wherein said first serpentine winding has more turns than the second serpentine winding.
